(19) United States
(12) Patent Application Publication
(10) Pub. No.: US 2020/0265536 A1
(43) Pub. Date: Aug. 20, 2020

(54) SYSTEM AND METHOD FOR ADMINISTERING DIVORCE AND CHILD CUSTODY BACKGROUND

(71) Applicant: Danielle Glover, Washington, DC (US)

(72) Inventor: Danielle Glover, Washington, DC (US)

(21) Appl. No.: 16/279,048

(22) Filed: Feb. 19, 2019

(51) Int. Cl. G06Q 50/22; G06Q 20/10; G01S 19/51

(52) U.S. Cl. CPC G06Q 50/22; G01S 19/51; G06Q 20/10

(57) ABSTRACT

A system for administering responsibilities among separated and divorced parents related to child custody. Child custody arrangements include a visitation schedule that outlines the time, place, and manner for custody exchanges, however, problems may arise due to ill-will and lack of effective communication and between parents. Disclosed is a system for organizing relations between custodial parents and interested parties such as courts and child services, including how, when and where child custody is to take place. A custody exchange is often a flashpoint for conflict between co-parents. To help each interested party understand and monitor a particular child custody situation, a database containing information related to child custody, accessible to members of a network is disclosed. Further, a means for communication and tracking of progress during a child exchange, along with monitoring of the custody exchange by third parties is disclosed.

The present disclosure generally relates to the field of methods for managing and administering visitations and other custodial responsibilities in child custody situations and for administering and managing issues related to divorce. The present disclosure relates generally to a system and method for sharing information about child custody. More so, the present invention relates to a system and method that informs a user, visitors to a network and members of a network to activities related to child custody and divorce associated with a user and the members of the network about issues relating to child custody and divorce.

Child custody and divorce arrangements are often emotional and contentious negotiations. Even divorcing parties that successfully manage to resolve financial or other issues sometimes find that the discussion about child custody and visitation can become heated, as can managing a relationship after a divorce without children. Most child custody arrangements include a custody and visitation schedule that outlines the time, place, and manner for custody exchanges, but sometimes problems still arise.

A child custody exchange, or “swap,” occurs each time a child goes from the physical custody of one parent to the other. These exchanges fall under the umbrella of “visitation rights” such that both parents are entitled to spend time with their children.

Due to the emotionally charged nature of child custody, however, these exchanges may become complicated. When disagreements occur, generally related to school, child rearing, and child support and emotions run high the exchange can become a dangerous situation. There are numerous examples in the law of violence occurring during a child custody exchange. Examples include violence between fathers and significant others of the mother, and violence between the father and mother.

These cases demonstrate the legal challenges that may arise during these highly emotional exchanges. While law enforcement may be called to help prevent or stop harmful behavior, particularly where a child is involved, law enforcement and the courts are typically limited in child custody matters to simply documenting what is occurring, or what has already occurred, for later review.

Violence or disagreement among parents during a child custody exchange can be harmful to the well-being of a child, and should therefore be minimize. Existing strategizing for minimizing conflict during a child custody exchange include exchanging in a safe publication location. In such a location, the presence of other people can minimize tension and potential conflict.

The presence of a neutral third-party can also minimize the risk of conflict. Having someone who's non-partisan when it comes to any past disputes with your child's other parent may reduce tensions while providing a reliable witness. Examples of neutral third parties include co-workers and school officials.

Another method of reducing conflict during exchange could be to have a third-party handle the exchange. A friend or family member may meet with the child to bring them to your vehicle, or pick them up without the parent to minimize contact between potentially feuding parents.

Another method for limiting conflict during child custody exchange include showing up to the exchange on time as expected. Conflicts may be triggered by seemingly minor inconveniences or having an argument over being a few minutes late. When emotions are involved, small disputes can quickly escalate.

U.S. Pat. No. 8,523,571 discloses a website for family organization and communication that enables internet access by both parents and their children for the managing, scheduling and sharing of information among the parents and children for issues relating to custody. Specifically, the tool provides for an access schedule calendar to which can be posted specific events requiring the pick up and drop off responsibilities of a parent. Additionally, the tool provides a means for electronically requesting a swap or trade in days of responsibility for a child and the tool provides for an “ask and approve” expense log for the sharing of children's expenses among parents. The tool further provides for date and time stamping of access by the parents or children to each web page within the tool and for protected entries, entries that can only be edited or deleted by the original creator.

U.S. Pat. No. 7,949,554 discloses a method, system and a computer program for calendar-based coverage monitoring. According to one aspect, a method includes receiving a coverage rule defining multiple covering entities for performing an activity for a covered entity and at least one period of time during which the multiple covering entities is to perform the activity. Individual calendars for the multiple covering entities are monitored and a change in one of the calendars is detected. It is then determined whether the change causes the coverage rule to be violated, and in response to determining that the change causes the coverage rule to be violated, a notification indicating violation of the coverage rule is generated. This system necessitates a monitoring component or person who determines if the “coverage rule” has been violated.

U.S. Pat. App. No. 20040133440 discloses a computer-based interactive system that provides tools for divorced parents to manage their parenting responsibilities such as custody arrangements, visitation, child support, and shared medical expenses. With the system of the '440 application, parents can share information about schedules, documents, activities and bills via their own secure, personalized website. Parents can become members of an internet-based system that enables them to manage the scheduling, contact management, bill payment, document management, and care situations that arise in a complex familial relationship.

While systems and methods for organizing child custody exist, problems still arise in the context of managing child custody exchange and maintaining and sharing a complete record of all relevant activities of the relevant parties. A system that provides the opportunity for real time information on the status and location of the relevant parties is needed.

### SUMMARY

The present invention is directed to a system and method that provides centralized child custody management and monitoring capabilities to interested parties which may include parents, attorneys, courts, child welfare facilities and law enforcement agencies. The child management, tracking and call processing functions of the present invention serves to organize actions related to child custody including transfer of custody and communications between parents and custody administrators. A network accessible by all interested parties collects and records information related to custody and allows for payment of child support, fees and other actions to take place online.

The present disclosure relates generally to a system and method for sharing information about child custody. More so, the present invention relates to a system and method that informs members of a network to activities related to custody used by the user and the members of the network. Accounts may be established at the website with an access right for both parents and other network members who may have a stake in the custody of a child. Location and telephone call information may be recorded by the network in real time, and compiled in a database in the form of automatically recorded calls from designated numbers, maps, global positioning system coordinates, audible alerts, images, and anecdotes. Members can share the information on the network; whereby an interested party may be notified about movement of the relevant parties, and store information relating to calls, messages and documents. A certificate, which may be printed, may be provided to a party demonstrating that child custody obligations have been fulfilled upon completion of a required task. The certificate may be stored and can be retrieved by network members or interested parties at a later time including parents, child custody services, government agencies and litigants.

The system for administering child support encompasses all aspects of handling child support matters between the interested parties. Handling child support requires coordination between multiple parties and can be fraught with problems that arise from miscommunication, mistakes or disregard for rules established by the court and child services. The myriad of issues that arise with regard to child support throughout the country evidences a need for an improved system for handling child support matters. Telephone calls between parties are recorded automatically and stored on the network. A GPS system may track a user by phone, vehicle or other form of GPS tag while custody is being transferred from one parent to another. This system may also be utilized for divorced or separated couples without children who may need to meet for other purposes, but wish to avoid conflict.

### BRIEF DESCRIPTION OF THE DRAWINGS

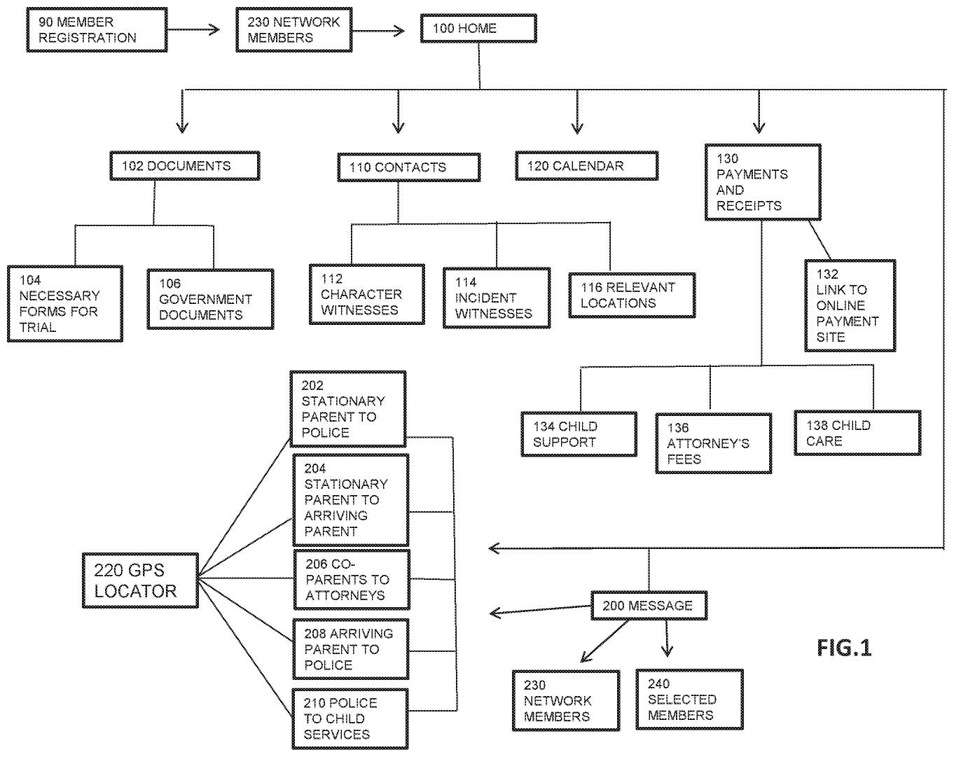

With regard to FIG. 1, flow chart shows a flow chart in one embodiment of the present disclosure.

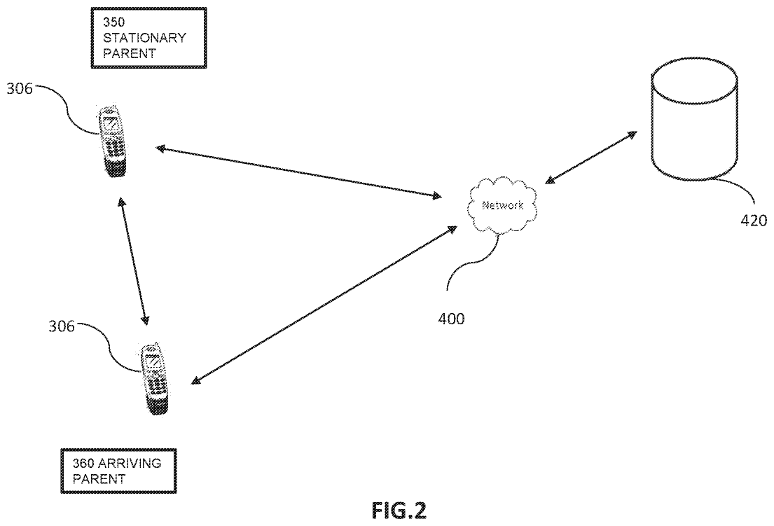

With regard to FIG. 2, a schematic diagram shows recording of calls between network members in a database.

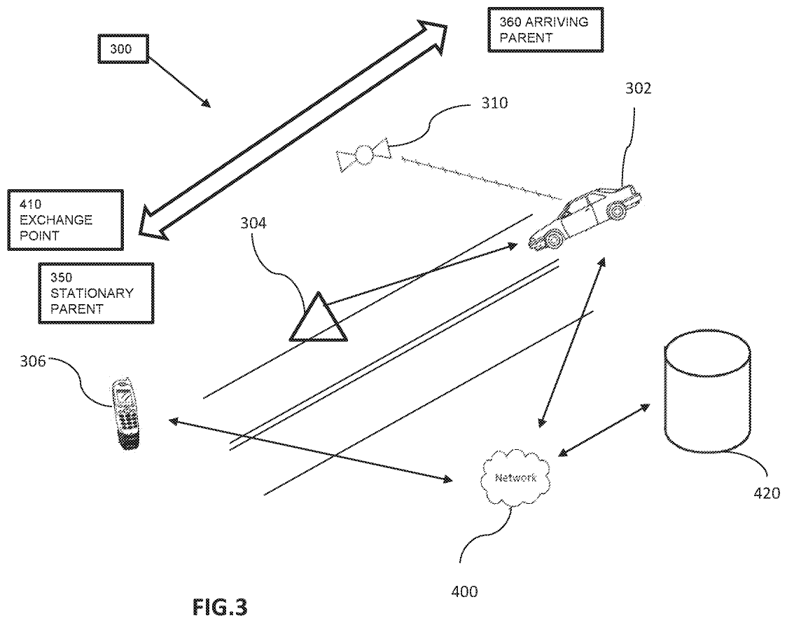

With regard to FIG. 3, a schematic diagram shows a child custody exchange according to the present disclosure.

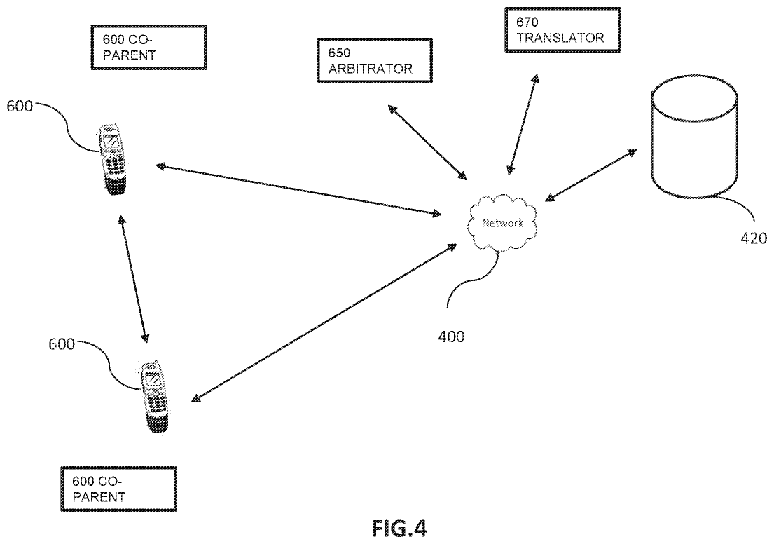

With regard to FIG. 4, a schematic diagram shows recording of calls between network members in a database including a call monitor.

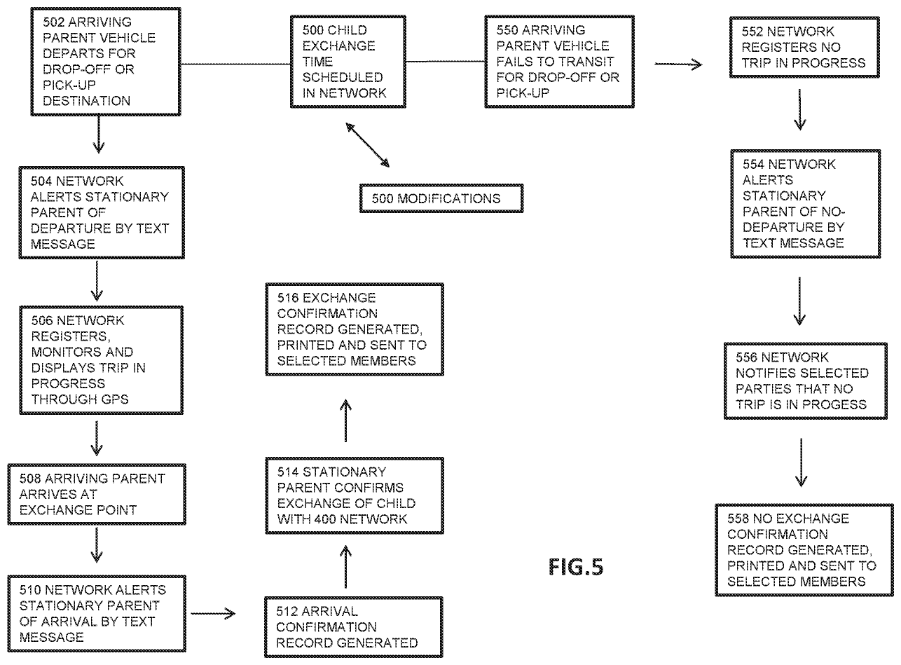

With regard to FIG. 5, a flow chart shows a child custody exchange method according to the present disclosure.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

The present disclosure relates to a method of organizing child support matters. Users may be involved in a dispute over custody over a child or may have visitation schedules regarding shared custody. Users may also be anticipating a custody dispute. Users may also wish to create a clear and concise line of communication with a co-parent. The network according to the present disclosure will permit users to upload documents that are pertinent to their case as well as personally identifiable information (PII). The network should be able to link accounts, track payments, upload documents, maintain information, and create a date/time and deliver and received date/time stamp, as well as track parties using a GPS system.

With regard to FIG. 1, network members 230 may access a website according to the present disclosure at a website home 100. The system and method of the present disclosure may begin with registration 90, as illustrated by the flowchart of FIG. 1. In some embodiments, registration 90 may be managed by a government service or a custodial parent. Home 100 may display to a network member a screen having a number of buttons, which may include access to documents 102 related to custody, including documents related to litigation, contacts 110, a calendar 120 and payments and receipts 130.

In one embodiment, information relevant to child custody is provided by a network member 230 who may have witnessed or received credible information. Network members 230 may then share the information to other network members 230 and for storage in the database 430.

System 300 may be used a tool for setting up child visitation (i.e., pick up time and location, drop off time and location, etc.) as well as monitoring the child custody exchange. System 300 acts as a third-party tool to make child custody exchange and visitation safer and more convenient. A stationary parent 350 may wait at a residence to have an arriving parent 360, which may be a co-parent, drop off a child. Direct communication between parties, via email or other means, may be preset in network 400 and may inform a user when a co-parent has requested a visitation arrangement, when changes were made to a pending visitation arrangement, and when a visitation request has been approved or denied. System 300 may be 508 compliant.

A lawyer may be provided access to network 400 and have the ability to print all necessary documents. In one embodiment, the account holder will have full access to the website while allowing the other parent to only have access to the calendar 120 and a request modification 500 page. If the non-account holder wishes to become a network member 230 they may register and link their calendar 120 and modification 500 request together which would allow both network members 400 to see the calendar 120 and a modification 500 request only, while maintaining their individual pages. Tabs for the network 400 may include documents 102, which may include trial documents 104 and government documents 106 such as a court order, as well as police reports and the like. A list of contacts 110 relevant to custody may include character witnesses 112, incident witnesses 114, and relevant locations 116.

Payments and Receipts 130 may include payments for lawyer fees, child support, and extracurricular activities. Payments and Receipts 130 may include a link to an online payment site such as PAYPAL™ of paying for child support, medical bills and other related payments.

A message 200 page may allow direct communication between lawyer and client, client and co-parent, lawyer and lawyer and other relevant network members 230. An account manager may select parties from network members 230 such that only chosen network members 230 are able to communicate through the message 200 page.

In one embodiment, a memo page may include notes to self and a to-do list. Further, a budget page may include daily expenses, weekly expenses, and monthly expenses. A contacts 110 page may include links to email, online payment site 132, a lawyer, or network members 230.

In one embodiment, subfolders may include a documents page 102, which may include requested documents, court orders and documents the lawyer is forwarding to you or other network members 230. Once a first subfolder is opened, it may list all the documents that may be subpoenaed during the trial process. For each document, a network member 230 may need to be able to upload requested documents and once uploaded check off from the previous page list. Another subfolder may contain court orders arranged by date with the most current court order first. An additional subfolder, under the documents 102 page, may be for any document a lawyer needs the user to sign, or that the user or the lawyer feels would be pertinent to your case. An additional subfolder may contain court decisions, legal issues, or military documents that may affect the out come of a case.

The contacts 110 page, may, in one embodiment, have 3 subfolders. One subfolder may be will be labeled incident witnesses 114. Incident witnesses 114 page may include all contacts that witnessed an incident related to child custody. Incident witnesses page 114 may include names, phone numbers, addresses, email, date/time of incident, and a brief overview of the incident. A network member may upload documents pertaining to the incident. Those documents may include a witness-typed overview of the incident. Another folder, labeled character witnesses 112 may be used to gather information regarding the character of a network member 230. Character witnesses 112 folder may include contacts such as a lawyer, co-parent, school information and medical care.

Calendar 120 page may include monthly, yearly and daily information regarding appointments and meetings, as well as visitation and child custody exchange information. In one embodiment, a parent or other network member may make a modification 500 request (shown in FIG. 5).

The calendar 120 tab, in one embodiment, have five subfolders. A first embodiment may contain a yearly calendar, which may include the year prior to the account being formed, to the year following the current year. Subfolder 2 for the calendar page may include the monthly calendar. The monthly calendar as well as the yearly calendar may be color coded to differentiate the mother's visiting days from the father's visiting days. Subfolder 2 will automatically calculate overnight visits for each parent. The user should be able to type on the calendar to insert appointments, events, meetings and the like.

Subfolder 3 for the calendar page may list doctor's appointments with columns that read date and time of appointment, whether it was scheduled or emergency, date and time you notified other parent, attendees, diagnosis, and incidents during. This subfolder may list any school related events/meetings. Columns may consist of date and time, scheduled or unscheduled, attendees, who called meeting, issue or event, and the outcome.

Subfolder 4 for the calendar page may show for pick-up and drop-offs. Subfolder 4 for the calendar page may list a date, who dropped the child off, who picked the child up, time that child was supposed to be dropped off, time they were dropped off, time the other parent arrived, and who picked up the child.

Subfolder 5 for the calendar page may be labeled modifications 500. This folder will have all modifications, request, approvals, or denials. It will have the request submitted by that parent. Requests should be numbered and highlighted according to each parent individually. It will also have the date and time requested, the reason for the request, date and time approved/denied, and the digital signature from both parents.

Subfolder 6 for the calendar page may be for payments. The subfolder will contain receipts and records with documented proof of purchases and payments related to child support. This may also include legal bills, record of payment, and date. Additionally, child care expenses date and time paid along with amount paid. An additional subfolder may include other activity that required payment.

An additional folder may contain a budget sheet to track daily, weekly, and monthly expenses, and a place to upload monthly bank statements.

Network 400 may include, in some embodiments, real time talk capability. Network 400 may include the ability to upload documents and videos. Network 400 may include a tone monitor. Network 400 may include the ability to request templates, modifications and logs. Network 400 may include essential medical information. Network 400 may include current court orders. Network 400 may include the ability to process debit cards for parents and children. The credit or debit card may include a co-card that co-parents may be able to use to make payments. Network 400 may include push notifications for both parents. Network 400 may include a date/time stamp for notifying when viewed. Network 400 may include contacts. Network 400 may include a means for viewing support payments and keep a log of support payments. Network 400 may include billing statements. Network 400 may include email capabilities. Network 400 may include a solo mode. Network 400 may include a document editor.

The network according to the present disclosure is capable of handling high volume. A memo folder for important notes may also be included. The network needs to have the ability to link numbers of network members 230.

As shown in FIG. 2, for selected members 240, which may be a stationary parent 350 and an arriving parent 360, a recording device associated with database 420 may automatically start recording a call, particularly during communications involving a child custody exchange. Further, text messages may be stored in addition to audio recordings. A log may consist of the date, time and length of call. Network 400 may include a messenger, a solo mode, a document editor, and a tone monitor.

With regard to FIG. 3, network 400 may be linked to a GPS 310 system for tracking arriving parent 360 during transfer of custody. In one embodiment, GPS 310 may be linked to multiple parties so that when an arriving parent 360 is traveling to the pick up or drop off location GPS 310 may show stationary parent 350 where arriving parent 360 is with a moving image, an ETA and whether there is an accident or construction on the route. A co-parent awaiting the arrival of another co-parent may be able to view the location of the co-parent on the way to a meeting point. Database 420 will store the departure and arrival time of the arriving parent, the date and any incidents that created a delay. Delays may be represented by a symbol of a construction sign or an accident. The system 300 may specify whether the arriving parent is picking up or dropping off child.

In one embodiment, a global positioning system 310 detects the location of an arriving parent 360, in order to alert a stationary parent 350 upon arrival. Determining the location of arriving parent 360 is made possible because global positioning system (GPS) 310 may operatively connect to network member's 230 communication device. This connection allows for communication between network members 230 and database 420 for sharing updated information and alerting network members 230 to changes in location in real time. Through this connection, network members 230 may verify and add information about changes in location, legal status, work status and other relevant information regarding custody, and then share this updated information with other network members 230.

In one embodiment, a message may be sent from an arriving parent 360 to network 400, and then from network 400 to stationary parent 350 showing a departure date, a destination address, a departure time and any delays that may be identifiable to provide an estimated time of arrival (ETA) for dropping of the child. In one embodiment, the message 200 may be generated automatically by the network 400. A confirmation record may be provided to the network 400 and to network members 230.

As shown in FIG. 3, the system 300 is configured to inform a stationary parent 350 with location information regarding an arriving parent 360 through network 400. Further, information about an obstacle 304, or hazard, wherein an obstacle may be defined as an occurrence that may cause delay in transit, can be shared through network 400.

In some embodiments, network 400 and a global positioning system 310 operatively connect to a portable communication device 306 of the arriving parent 360 or other network members. The location of the arriving parent 360 may be operatively connected to network 400. Selected members 240 may be chosen to receive certain messages or access to network 400 that other network members 230 do not. In this manner, a message 200 may be transmitted to network members 230, which may consist of all members of network 400 related to a case, or selected members 240 to alert and notify about a delay or non-transit additional information.

Further, network members 230 may verify and add information about the transit, and then share this updated information network members. In this manner, network members 230 may respond by sending a supervisory official or police officer to a location, or make a call to arriving parent 360, or provide a confirmation record for litigation purposes.

In one embodiment, system 300 may be operable as a downloadable software application. The digitized, wireless configuration of the software application enables network members 230 to indicate to other members 230 about a child custody exchange in real time. This instantaneous information about a child custody exchange enables a software application to automatically alert stationary parent 350 about potential problems. If a child custody exchange is not completed law enforcement may be informed and may issue an alert to the public.

In some embodiments, a facetime feature in network 400 may allow a parent that does not currently have current custody of the child to schedule a facetime or send a facetime request in advance. The facetime feature may list whether the other parent approves a request and may record the video.

Thus, a real time system for sharing information about child custody exchange is needed. In yet another embodiment, system 300 may be cloud based and accessible via the Internet. In yet another embodiment, system 300 is configured for use on a desktop operating system and a mobile operating system.

In some embodiments, network members may include parents, relatives, court officials, law enforcement, child services officials and others who may have an interest in the custody of a child. In other embodiments, network 400 may include a social network, a network of commuters and a first response network. Database 420 stores information about child custody 108.

In some embodiments, an arbitrator 650, or other official involved in custody, may, through network 400, view the locations of both arriving parent 360 and stationary parent 350 to determine whether they have become too close in proximity in order to avoid a potential conflict. An alert may be generated through network 400 when distances between arriving parent 360 and stationary parent 350 reach a proscribed distance. A transmitted alert may include, without limitation, an audible signal, vibration, message, a text, an email, and a phone call.

In one embodiment, a hearing-impaired mode in network 400 may allow for the use of a translator 670 during communications between network members 230, and for the use of patterns over colors for color blind people, wherein both hearing and visually impaired related communications may include the ability to record video. Network 400 may be 508 compliant to make electronic and information technology (EIT) accessible to people with disabilities. Online video communications may be transmitted to network 400 to assist in communications between network members 230 with disabilities. Translators may be present via video for the hearing impaired, and such communications may be recorded and stored in database 420. Furthermore, network members 230 may notify other network members 230 about any situation that may cause delay in a child custody exchange.

With regard to FIG. 4 co-parents 600 may have communications monitored in real time through network 400 by a third-party such as an arbitrator 650 or another official such as a lawyer. Real time communication may include text, video and call. An arbitrator, or other third-party monitor 650, may monitor and intervene in a communication between co-parents 600 when deemed appropriate. Monitoring may occur through network 400 such that third-party monitor 650 may be able to monitor and regulate communications between parties. The sending party may be privy to the third-party monitor being involved in a communication without the knowledge of the receiving party. The third-party monitor may, upon recognizing that a communication has become problematic, block a communication. The third-party monitor 650 may also step into the place of the sending party to communicate to the receiving party. The third-party may be able to monitor a real time communication such that there is a time delay placed on communications prior to the communication being sent, such that the third-party can review the communication and block the communication if necessary. Such communications between the arbitrator 650 and co-parent 600 may, in one embodiment be recorded by a recording device in database 420.

A person of ordinary skill in the art will appreciate that system 300, as shown in FIG. 3 and FIG. 4, is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system configurations.

Network 400 may be a computer-based system for managing child custody and divorce, including one or more telephones and computer terminals, the system comprising:

A networking device exchanging voice over internet protocol (VoIP) data packets with call processing gateways over communication links, the call processing gateways processing the VoIP data packets to or from the telephone for transmission over the communication links.

A child custody management system coupled to the networking device for providing shared data access of child custody records to computer terminals at multiple facilities, said custody records created with child custody information input into a database 420 through network 400 by at least one member of the network.

A call application management system connecting a call to or from the telephones over a telephone carrier network responsive to receiving a request for connecting the call and the call being authorized based on the child custody records provided by the child custody and divorce management system. In the present system, calls and text messages may be routed through 400 to be monitored by a third-party monitor 650.

With regard to FIG. 5, a flow chart representing one embodiment of system 300 present disclosure during a child custody exchange 500. Once a child custody exchange time is scheduled in network 400, the child custody exchange may occur or it may fail to occur. If the child custody exchange occurs as scheduled in network 400, in a first step, the arriving parent vehicle will depart for drop-off or pickup destination 502. Once this occurs, in a next step, the network will alert the stationary parent of the departure by text message 504, or another designated means of communication. Next, the network may register, monitor and display the trip of the arriving parent such that network members may observe progress through GPS 506. Once an arriving parent arrives at the exchange point 508, the network may alert a stationary parent of the arrival by text message 510 or other means of communication. Next, an arrival confirmation record may be generated 512. The stationary parent may then confirm exchange 514 with network 400. Network 400 may then generate a record 516, which may be printed, and then send the record to selected members 240.

Alternatively, if the child custody exchange does not take place as planned, the network 400 may signal that the arriving parent vehicle has failed to transit for drop-off or pick-up to the exchange point 550. In this case, the network will register no trip is in progress 552. The network may then alert the stationary parent that no-departure has taken place 554 by text message or other means of communication. A no exchange confirmation 556 may then be sent to selected members generate a record 558 in digital and print form for storage as a legal record.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

1. A method comprising:
recording, by at least one member of a network, information relating to child custody in a database;
sharing the recorded information about the child custody with the database and the least one member of the network;
verifying the information about the child custody by the least one member of the network;
designating in the network a route to be taken during a child custody exchange;
detecting a position of an arriving parent and a position of a stationary parent within the network, relative to the route, with a global positioning system;
tracking, within the network, a position of the arriving parent such that the least one member of the network may view progress by the arriving parent along the route;
inputting into the network any obstacles that occur during transit along the route;
notifying the stationary parent upon arrival of the arriving parent at an exchange location;
sharing the position of the arriving parent and the position of the stationary parent in real time with at least one selected member of the network other than the arriving parent and the stationary parent;
confirming within the network, by the stationary parent, that the child custody exchange has occurred;
generating a certificate indicating a location, a date, and a time that the child custody exchange has occurred;
providing the certificate through the network to the at least one selected member to confirm that the child custody exchange has occurred; and
storing the certificate such that the certificate can be retrieved and viewed by the least one member of the network; of the network.

2. The method of claim 1, further comprising a step of paying a fee to search at least one of the network and the database.

3. The method of claim 1, wherein the network includes at least one of a parent of a child, a relative of the child, a court official, a lawyer, a police officer, and a child services official.

4. The method of claim 1, wherein the database includes a geographical database configured to store travel information about the arriving parent.

5. The method of claim 1, further comprising a step of notifying at least one member of the network when the arriving parent is proximal to the exchange location, wherein notifying is with an audible signal, vibration, message, a text, an email, and a phone call.

6. The method of claim 1, wherein the method is configured to be operable on a desktop operating system, website and a mobile operating system.

7. The method of claim 1, wherein each parent has a co-card for shared expenses.

8. The method of claim 1, wherein the database is operatively connected to a mobile communication device.

9. A method comprising:
recording, by at least one member of a network, information relating to child custody in a database;
sharing the recorded information about the child custody with the database and the least one member of the network;
verifying the recorded information relating to child custody by the least one member of the network;
designating a third-party monitor to monitor a child custody exchange;
accessing, by the third-party monitor, the recorded information relating to child custody in the database;
monitoring by the third-party monitor, within the network, communication between a first parent and a second parent, wherein the communication is related to child custody;
restricting, by the third-party monitor, communication between the first parent and the second parent, based on content of the communication;
recording, within the network, communication between the first parent and the second parent;
detecting a position of an arriving parent and a position of a stationary parent within the network with a global positioning system;
tracking, within the network, a position of the arriving parent;
identifying, within the network, any obstacles that occur during transit along a route traveled by the arriving parent;
notifying the stationary parent upon arrival of the arriving parent at an exchange location;
sharing the position of the arriving parent and the position of the stationary parent in real time with at least one selected member of the network other than the arriving parent and the stationary parent; and
confirming within the network, by the stationary parent, that the child custody exchange has occurred;
generating a certificate indicating a location, a date, and a time that the child custody exchange has occurred;
providing the certificate to the at least one selected member to confirm that the child custody exchange has occurred;
storing the certificate such that the certificate can be retrieved and viewed by the least one member of the network of the network at a later time.

10. The method of claim 9, wherein the third-party monitor reviews the communication between a sending party and a receiving party prior to receipt of the communication from the sending party to the receiving party.

11. The method of claim 10, wherein within the network, the third-party monitor forwards the communication between the sending party and the receiving party to the receiving party by pressing a forward button.

12. The method of claim 9, wherein restricting the communication involves blocking communication between the sending party and the receiving party.

13. The method of claim 9, wherein restricting the communications involves the third-party monitor communicating on behalf of the sending party.

14. The method of claim 9, wherein the receiving party receives the communication from a sending party on a time delay and the third-party monitor receives the communication in real time, thereby allowing the third-party monitor to review the communication prior to receipt by the receiving party.

15. The method of claim 9, wherein the network includes at least one of a parent of a child, a relative of the child, a court official, a lawyer, a police officer, and a child services official.

16. The method of claim 9, wherein the database includes a geographical database configured to store travel information about the arriving parent.

17. The method of claim 9, further comprising a step of notifying the least one member of the network when the arriving parent is proximal to the exchange location, wherein notifying is with an audible signal, vibration, message, a text, an email, and a phone call.

18. The method of claim 1, wherein the method is configured to be operable on a desktop operating system, website and a mobile operating system.

19. The method of claim 1, wherein the method is operable with a mobile communication device.

20. A method comprising:
recording, by at least one member of a network, information relating to a divorced couple in a database;
sharing the recorded information about the divorced couple with a database and the least one member of the network;
verifying the information about the divorced couple by the least one member of the network;
inputting into the network a route to be taken during a meeting between the divorced couple;
detecting a position of an arriving party and a position of a stationary party within the network, relative to the route, with a global positioning system;
tracking, within the network, a position of the arriving parent such that members of the network may view progress by the arriving parent along the route;
inputting into the network any obstacles that occur during transit along the route;
notifying the stationary party upon arrival of the arriving parent at an exchange location;
sharing the position of the arriving party and the position of the stationary party in real time with at least one selected member of the network other than the arriving party and the stationary party; and
confirming within the network, by the stationary party, that the meeting between the divorced couple has ended;
generating a certificate indicating a location, a date, and a time that the meeting between the divorced couple occurred;
providing the certificate through the network to the at least one selected member to confirm that the meeting between the divorced couple occurred;
storing the certificate such that the certificate can be retrieved and viewed by members of the network.
